(19) United States
(12) Patent Application Publication
(10) Pub. No.: US 2007/0107766 A1
(43) Pub. Date: May 17, 2007

(54) Multi-source ambient energy power supply for embedded devices or remote sensor or RFID networks

(76) Inventors: John B. Langley II, Half Moon Bay, CA (US); Boy Yann Liaw, Honolulu, HI (US); Scott A. Weeker, Kihei, HI (US)

Correspondence Address: LEIGHTON K. CHONG;PATENT ATTORNEY, 133 KAAI STREET, HONOLULU, HI, 96821, US

(21) Appl. No.: 11/273,224

(22) Filed: Nov. 12, 2005

(51) Int. Cl. H02K 7/18; H02J 7/00; H02N 6/00

(52) U.S. Cl. 136/243; 320/101; 290/1 R

(57) ABSTRACT

An ambient electromagnetic energy collector has a magnetic core of high permeability ferromagnetic material wrapped in an inductor coil for coupling primarily to a magnetic field component of a propagating transverse electromagnetic (TEM) wave. For coupling to electromagnetic waves of a wide range of frequencies and magnitudes, the collector is coupled to a multi-phase transformer connected to a multi-phase diode voltage multiplier to provide a current source output to an associated energy storage device. An output controller supplies output power as needed to the associated energy-using device. Preferred types of ferromagnetic materials include nickel-iron alloys with a small percentage of silicon, molybdenum, or copper. It may be combined with other types of ambient energy collectors, such as acoustic/vibration, thermoelectric, and photovoltaic collectors, in a multi-source device provided with a collector interface for converting the different outputs for storage in a common energy storage device. The multi-source ambient energy collector device can be used to supply power to embedded devices, remotely deployed wireless sensors or RFID tags, and other types of monitoring devices distributed over large areas or in industrial environments.

### TECHNICAL FIELD

This invention generally relates to a device or system for collecting energy from ambient energy sources and providing it as a power supply for embedded devices or remote sensor or RFID networks.

### BACKGROUND OF INVENTION

Wireless sensor devices and active RFID tags are limited by the operating life, size, costs, and toxicity of their chemical battery power systems. For embedded and remotely distributed applications, the replacement or recharging of sensor and RFID batteries is impractical and costly. As military and commercial operations increasingly incorporate the use of embedded sensors and remotely distributed wireless devices for “pervasive computing” and “persistent surveillance” applications, there is the corresponding requirement for an alternative, long-lasting power supply that is self-sustaining, reliable and maintenance-free over multiple years of operations in harsh conditions.

For applications that require the mass deployment of disposable wireless sensors (e.g. for border monitoring in wilderness areas), the eventual decay of the sensors' chemical batteries can result in the release of harmful battery chemicals and heavy metals into ground water and the atmosphere. For these disposable wireless device applications, the challenge is to develop an alternative power supply that is long-lasting, low-cost, and environmentally-friendly.

Commercially, there is also the growing global need to develop alternative power sources to supplement the power-hungry rechargeable batteries of cell phones, MP3 players and other personal electronic devices. In addition, as new military and commercial applications increasingly require lightweight, highly mobile systems, there is also the need for the capability to remotely activate and power electronic devices and data communications systems. For military applications, this capability would support applications such as: providing stand-off power to recharge the batteries for ground troops, (via airborne, ground or space-based systems); battlefield “Identify Friend or Foe” (IFF) systems; and covert pilot search and rescue. Commercial applications could include: battery-less active RFID tags for shipping container security; low cost, passive tracking and location of personnel, equipment, and controlled pharmaceuticals; hybrid RFID tags for inventory tracking of liquid and metal items; disaster mitigation; and encrypted identity/access control cards, RFID tags, and passports.

### SUMMARY OF INVENTION

To solve the need for a power supply for an associated energy-using device that can be deployed anywhere and is self-sustaining, reliable and maintenance-free over its service life in potentially harsh conditions, the present invention provides an ambient electromagnetic energy collector that couples to an ambient electromagnetic field around the device to extract energy from the ambient electromagnetic field, having an inductor structure for coupling to a magnetic field component of the ambient electromagnetic field so that it can be substantially reduced in size as compared to an antenna structure for coupling to the electric field component of the ambient electromagnetic field.

In accordance with the invention the ambient electromagnetic energy collector is used in an ambient energy collector and power supply device having an associated energy storage device for storing the extracted energy and supplying an energy output therefrom to an energy-using device. The device can thus be used as a self-contained, self-sustaining power supply for embedded devices, or remote sensor or RFID networks over a long life cycle period, without the need for battery changing or other servicing.

In the preferred embodiments, the ambient electromagnetic energy collector comprises a magnetic core element of high permeability ferromagnetic material that is wrapped in an inductor coil for coupling primarily to the magnetic field component of a propagating transverse electromagnetic (TEM) wave and providing an induced voltage output. With ambient electromagnetic waves of potentially a wide range of signal frequencies and magnitude, the induced voltage output is coupled to a multi-phase transformer which is connected to a multi-phase diode voltage multiplier to provide a current source output that is stored in the energy storage component. An output controller supplies output power as needed to the associated energy-using device.

The TEM coupling is designed to be optimized in coupling to magnetic fields over a wide frequency range of ambient electromagnetic waves. Preferred types of ferromagnetic materials having high relative permeabilities include nickel-iron alloys comprised of a high percentage of nickel, smaller percentage of iron, and very small percentage of elements such as silicon, molybdenum, or copper.

The present invention also encompasses a multi-source ambient energy collector and power supply device for supplying power to a low-power energy-using device deployed or embedded remotely in a field application comprising a plurality of types of ambient energy collectors each for extracting energy from a different source of ambient energy available in the field around the device, and a multi-source ambient energy collector interface which is coupled to the different outputs of the plurality of types of ambient energy collectors and converts the outputs into a common electrical form for storage in an associated electrical energy storage device. Besides the ambient electromagnetic energy collector, the device may also include an ambient acoustic/vibration energy collector for collecting energy from ambient sound or vibration energy sources, an ambient thermoelectric energy collector for collecting energy from ambient thermal energy sources, and an ambient photovoltaic energy collector for collecting energy from ambient light and/or sunlight. The multi-source ambient energy collector allows for aggregation of energy from several classes of ambient energy sources for conversion into a common form for electrical energy storage.

This invention also includes a “smart switch” that can be used to trigger power release from the energy storage component of the ambient energy collector and power supply device for supplying power on demand to the associated energy-using device. This triggering mechanism can use the same magnetic coupling of the ambient electromagnetic energy collector to transmitted RF electromagnetic waves to generate a specific voltage level or current pulse to activate power release to the energy-using device. This mechanism can provide a secured and on-demand power source for embedded devices or remote sensor or RFID networks to wake up and perform their function, and has a unique capability for preventing tampering for secured operation.

Other objects, features, and advantages of the present invention will be explained in the following detailed description of the invention having reference to the appended drawings.

### BRIEF DESCRIPTION OF DRAWINGS

FIG. 1 is a schematic diagram showing an ambient energy collector and power supply device used to extract energy from ambient energy sources and supply power to an associated energy-using device.

FIG. 2 is a graph illustrating a typical frequency spectrum of ambient electromagnetic energy.

FIG. 3 is a graph illustrating the cumulative density of typical ambient electromagnetic energy as a function of frequency.

FIG. 4 is a schematic diagram showing an ambient electromagnetic energy collector formed with a cylindrical magnetic core and inductor.

FIG. 5 is a schematic diagram showing a preferred collector circuit for the ambient electromagnetic energy collector.

FIG. 6 is a schematic diagram showing a preferred embodiment of a multi-source ambient energy collector architecture.

FIG. 7 illustrates a multi-source ambient energy collector and power supply device for use as an inexhaustible energy source for sensors, RFID tags, and small electronic devices.

### DETAILED DESCRIPTION OF INVENTION

In the following detailed description, certain preferred embodiments are described as implemented in specific types of applications and field environments with specific details set forth in order to provide a thorough understanding of the present invention. However, it will be recognized by one skilled in the art that the present invention may be practiced without these specific details or with equivalents thereof. In other instances, well known methods, procedures, components, functions have not been described in detail as not to unnecessarily obscure aspects of the present invention.

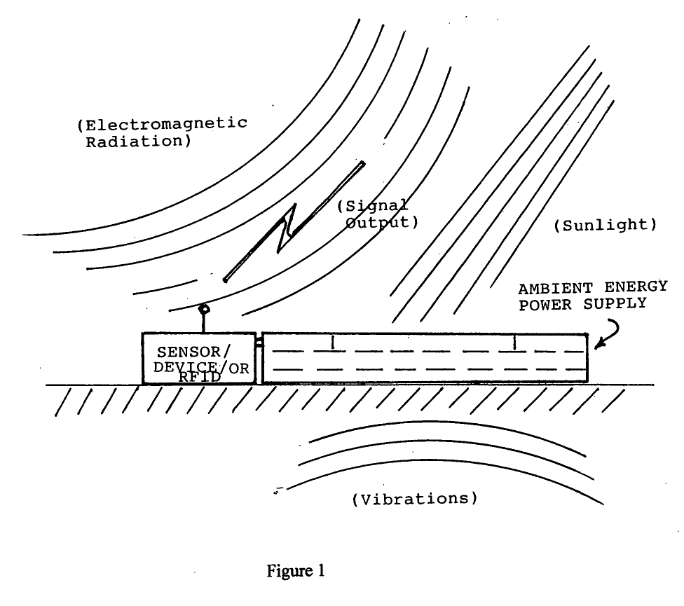

Referring to FIG. 1, an ambient energy collector and power supply device is shown having at least one ambient energy collector 10 for extracting energy from ambient energy sources in the environment around the device and storing it in an energy storage device 12. Using an output controller, the power supply device can supply power as needed to an associated energy-using device 20. The ambient energy collector and power supply device is designed to be self-contained and environmentally sealed without the need for any mechanical coupling to any external elements other than the associated energy-using device 20. As long as there are ambient energy sources in the surrounding environment from which sufficient energy can be extracted to supply the energy needs of the energy-using device 20, the ambient energy collector and power supply device can be deployed anywhere in that environment and is self-sustaining, reliable and maintenance-free.

The associated energy-using device 20 can be any type of sensor, RFID tag, or small electronic device that is intended to be deployed to operate over long periods of time in remote environments without the need for any battery changes, maintenance, repair, or other servicing. Many types of such field-deployable devices are being designed to take advantage of the current technological advances in processing speeds, reduced thermal dissipation, dense integrated circuitry, reduced size, and lower power consumption, to provide a unit capable of high functionality while having a low physical profile and low heat emission or energy consumption. The smaller die size can allow either more functions to be incorporated within a single device—the “System on a Chip” concept—or to reduce the size and power consumption of an existing device. By reducing the size of the individual device, more of them can be fabricated on a single wafer with higher yield, driving down the cost per device.

Many products have been offered that can provide communication, control or sensing functions with price, performance and power consumption that can enable many new applications. Of particular interest is the implementation of wireless mesh network architectures in which each node in the network works to relay data between other nodes in the network. The attractive feature of this type of network structure is that no single member of the network needs to be able to communicate over long distances, only to the next node. This feature allows extremely low-power and low-cost devices to communicate over large distances or as an array with mesh architecture. Enabled by the current advances in semiconductor process technologies, sensing or control functions can be implemented with these low-power technologies on the same device as the communication functions. Applications for these sorts of devices range from sensors that might deployed in a remote environment to Radio Frequency Identification (RFID) tags deployed on products to be tracked by a mass-market retailer.

While the lowered power requirement can now make battery power a viable option for many applications, ultimately energy stored in the battery will be consumed. When the battery is depleted, it either must be replaced or the entire device abandoned or discarded. Further, for applications that require unattended service lifetimes measured in years, or where the device is located in a remote or hostile place, battery replacement is not a viable option. An additional undesirable artifact of most battery chemistries is that the disposal of depleted batteries can result in release of harmful and long-lived toxic compounds into the environment.

The present invention is thus designed to extract energy from ambient energy sources to supply power to a low-power device over a long service life without the need for any battery changes, maintenance, repair, or other servicing. Urban and suburban areas are bathed in waves of electromagnetic energy at radio frequencies that can be tapped for supplying power to such low-power devices. In addition, commonly available sources like light from the sun or artificial light sources and heat from naturally occurring processes or human activities, as well as acoustic and mechanical vibration energy sources can be scavenged to provide power for low-power consumption electronic devices.

Ambient Electromagnetic Energy Collector:

A principal development in the present invention is an ambient electromagnetic energy collector that can extract useful energy from ambient electromagnetic radiation spanning a wide range of frequencies. Prior art in the field of electromagnetic energy collection has been largely focused on the use of collectors optimized for a specific frequency, such as the work by NASA laboratories to remotely power satellites by means of tightly directed, high-power beam of microwave energy from another satellite. The use of a dedicated power source to provide energy to a device specifically tuned to that frequency is not viable for applications where the devices may be distributed over a large area, such as a network of intrusion sensors distributed along a national border.

For the single-frequency, directed-beam approaches, microwave frequencies are often used so that antennas can be made physically smaller as a function of the shorter wavelength. But the physics of propagation of electromagnetic waves result in attenuation of the electromagnetic field strength as a function of distance. While the actual attenuation is a complex phenomenon and dependent on the characteristics of the transmission path, the field strength is attenuated at least as the square of the path distance, measured in wavelengths. For a given distance, the lower frequency with its longer wavelength has less propagation loss. Thus, for efficiently distributing power over the largest area, using lower frequencies such as common RF radiation would be more effective.

Ambient RF energy is created by a large number of sources, such as wireless transmission services in use for communication and other applications such as radiolocation and radar. The highest power sources are dedicated to broadcast services that provide either radio or television signals to customers over a broad region. The main bands of interest in the US are the AM broadcast band from approximately 500 Kilohertz to approximately 1700 Kilohertz, the FM broadcast band from 88 to 108 MHz and the television bands. Television channels are distributed in three spectral segments, one from 52 to 87 MHz, one from 174 to 216 MHz, and 470 to 700 MHz. By the rationale above, one would expect that the measured distribution of ambient energy would reflect both the frequency distribution of these high powered broadcast services and the path loss dependence on frequency.

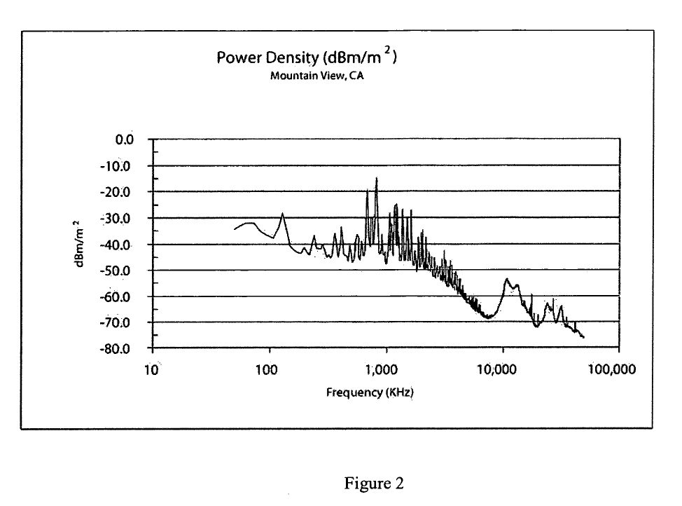

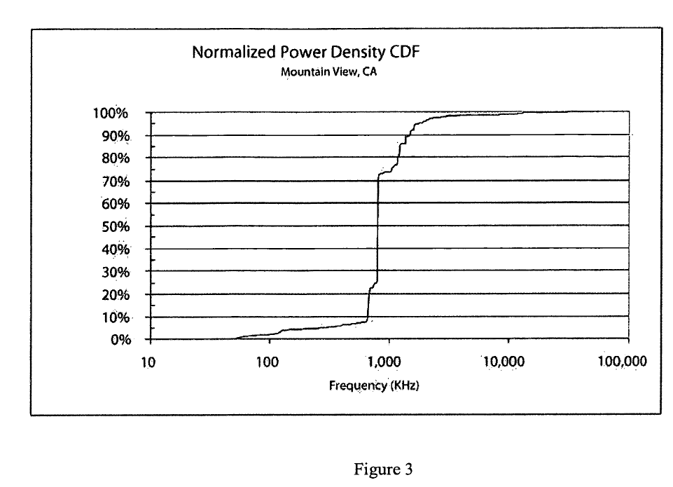

FIG. 2 shows a distribution of RF power density as a function of frequency in a typical suburban area. The data shown in FIG. 2 were measured at a site in Mountain View, Calif. The shape of the plot indicates that there are many contributors to the ambient electromagnetic energy at a number of different frequencies from 50 Kilohertz to 50 Megahertz. FIG. 3 shows the cumulative distribution of RF power density for the site as measured in FIG. 2. The shape of the plot indicates that the majority of the RF power is in frequencies from 50 Kilohertz to 50 Megahertz as contained in the AM broadcast band. From examination of the distribution of AM broadcast stations throughout the US, one can infer that similar ambient energy levels should be found in most metropolitan areas. Due to very significantly greater path loss at the TV and FM broadcast frequencies, the power density in these bands was substantially less than in the AM band.

The data shown in FIGS. 2 and 3 demonstrate that the presence of a broadly distributed source of ambient electromagnetic energy in typically populated environments might be harvested to provide a long term power source for low power electronic devices. The lower frequency bands offer the advantage of proportionally less attenuation as a function of distance because of their longer wavelength. Additionally, the lower frequencies more readily penetrate common structures like buildings and vegetation thus allowing more uniform access to this energy source.

While the lower frequencies offer significant advantages in terms of ubiquity of ambient energy distribution, efficiently collecting this energy has been difficult. Signals transmitted from sources such as AM broadcast stations are known as Transverse Electromagnetic (TEM) fields. In a TEM field, the propagated energy is contained in both an electric and magnetic field component. For many, largely historic, reasons it has been traditional to couple signal reception to the electric field component of the propagating wave. Antenna structures that couple to the electric field are fundamentally capacitive elements and need to be dimensionally commensurate to the wavelength of the signal to which it couples. For the frequencies of interest here, in the 100's to 1000's of kilohertz with wavelengths in many hundreds of meters, the physical dimensions of a high-efficiency electric-field antenna must be similarly large. A large antenna size would seriously limit the usefulness of an ambient electromagnetic energy collector that couples to the electric field.

Since the propagating energy is equally distributed between the electric magnetic field components, the present invention employs a collector that couples to the magnetic field as an equally viable alternative to an electric field antenna While structures that couple to the electric field are fundamentally capacitive, a structure that couples to the magnetic field is fundamentally inductive. As will be shown, an inductive structure can be substantially reduced in size by appropriate design.

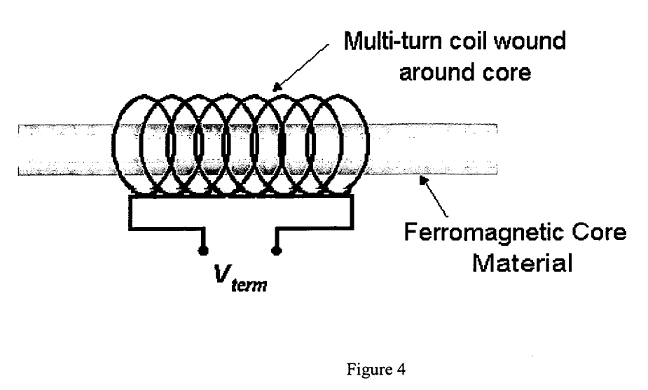

FIG. 4 shows the structure of a typical cylindrical inductor that might be used as a pickup for ambient electromagnetic energy by coupling to the magnetic field of the ambient electromagnetic fields. The cylindrical inductor consists of a magnetic core 40 in a cylinder shape wound with a wire coil 42. The coil ends provide an output voltage when induced by coupling of the magnetic core 40 with an ambient electromagnetic field. While the cylindrical inductor is shown as the collector element for convenience of description, there are many other inductive structures that could be employed for the same purpose.

An inductor in a uniform, sinusoidal magnetic field provides a terminal voltage that is given by:
Vₜₑᵣₘ=2πfHAμ₀μᵣN
In which:
f=frequency in Hertz
A=inductor cross section (m²)
H=magnitude of incident magnetic field (amperes/meter)
μ₀=4π×10⁻⁷ (permeability of free space)
μᵣ=effective relative permeability of the core material
N=the number of turns of wire forming the inductor

In the above expression the quantity, Aμ₀μᵣ, represents an “effective area”. Thus the physical area of the inductor is multiplied by the permeability of the core. Thus the physical area of the inductor is multiplied by the permeability of the core. The effective relative permeability of the core material is a function of both the ferromagnetic properties of the core and its physical dimensions. By selection of a material having a large effective relative permeability, an inductive pickup can be constructed that will have a large “effective area” while still having a small physical area. This is the key method used in the present invention to construct a physically small, low-frequency electromagnetic energy collecting device, and represents the major advantage of coupling to the magnetic component of the incident electromagnetic field as compared to the electric field component.

The effective relative permeability is a measure of the ability of the core material to “concentrate” the incident magnetic field. The cylindrical structure shown in FIG. 4 is an example of an “open” magnetic structure in which the lines of constant magnetic field extend outside the core material. This property is the method by which the magnetic pickup couples to the incident magnetic field, but also reduces the effective permeability due to the amount of the magnetic field that is outside the dimensions of the core material. The relationship between the physical dimensions of the core and its effective material is quite complex but generally core shapes having a large length to diameter ratios are preferable.

There are a several types of ferromagnetic materials having usefully high relative permeabilities that can be employed here. Among the more interesting materials are a family of nickel-iron alloys comprised of a high percentage of nickel, smaller percentage of iron, and very small percentage of elements such as silicon, molybdenum, or copper. By application of contemporary materials design techniques, a ferromagnetic core material can be constructed optimal electromagnetic properties combined with desirable physical parameters such as small size and machinability. The use of magnetic antenna structures in AM radios enjoyed a brief period of popularity in the 1950 and 1960's. Antennas using ferrite core materials were shown to very effective alternative to long wire antennas and substantially smaller. The ferrite antennas designs utilized in AM radios differed fundamentally in that they were tuned to a single frequency as part of the station selection function, whereas the ambient electromagnetic energy collector is designed as a broadband device able to collect incident energy over a wide range of frequencies.

The requirement of operation over a wide frequency range requires that the magnetic ambient energy pickup be free of resonances within the band of interest. A resonance is formed when the capacitive component of the complex impedance of a circuit equals the inductive component. While the magnetic ambient electromagnetic pickup here is inductive in nature, there are capacitive elements introduced both from parasitic capacitance in the coil wound on the core and capacitance from the attached circuitry. Capacitance in the attached circuitry can be minimized through good circuit design but parasitic capacitance in the winding itself must be minimized by controlling the number of turns wound on the core, the physical geometry of the winding and the core and wire properties. The design of the winding pattern is an integral part of the design of the electromagnetic pickup.

RF magnetic collector laboratory breadboard were constructed to confirm the design model and to compare the prototypes' collected energy measurements against the actual RF field strength readings captured using a spectrum analyzer. The breadboards confirmed that the RF magnetic collector becomes immediately active in the presence of a low frequency RF field and requires no “warm-up” period. The breadboards each utilized a combination of “off the shelf” ferrite cores with wound coils tuned to narrow sections of the AM band to function as a limited facsimile of a full broadband collector. The breadboards were used in extensive modeling and simulation of the performance of both the magnetic and electronic components. In these breadboard units, the electromagnetic characteristics (permeability) of the ferrite-cored RF magnetic collector (e.g., its ability to concentrate the magnetic field), is relatively low. Expressed in terms of permeability, the ferrite's intrinsic permeability is approximately 100, while its effective permeability is approximately 52.

By selecting and designing the core material for increased permeability, it is possible to significantly increase the total amount of RF energy collected while keeping the same physical size, or, conversely, reducing the physical size while maintaining the same amount of collected energy. The effective permeability of the core is a complex function of both the intrinsic permeability of core material and the physical geometry of the actual core. The effective permeability is always much less than the intrinsic permeability for the cylindrical core shapes needed for this application. Because of this, simply replacing the collector core with one made from a material with much higher intrinsic permeability will not increase the output in a simple ratio to the change in intrinsic permeability. It is expected that more advanced ferro-magnetic alloys can be selected and designed to have an intrinsic permeability in the vicinity of one million. This will potentially increase the intrinsic permeability by a factor of more than 10,000, thereby significantly increasing the extraction output of the RF magnetic collector, reaching milliwatt levels of continuous power.

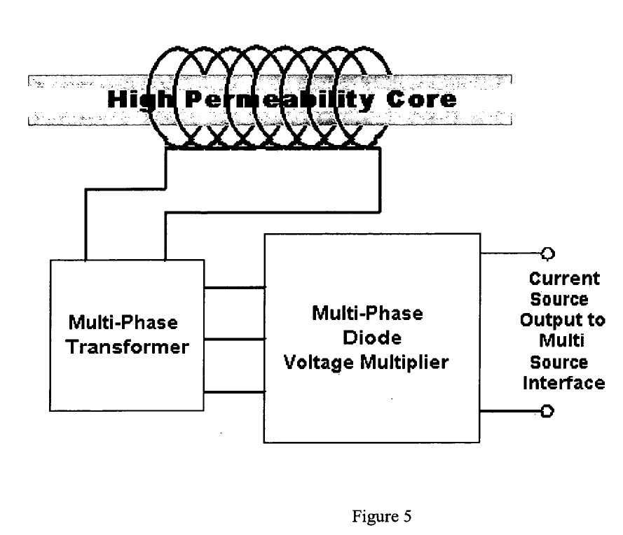

FIG. 5 shows a block diagram of the elements providing the collector function of the ambient electromagnetic energy collector. The output of the inductive pickup is typically in the range of tens of millivolts for the expected range of incident field strengths. The output of the pickup is connected to a multi-phase transformer to increase the voltage to a value suitable for application to a multi-phase capacitor-diode voltage multiplier (CDVM). The multi-phase transformer accomplishes three functions. First, it creates at least two outputs with a phase relationship such that the ripple currents in the CDVM outputs will be minimized. This is necessary since the CDVM structure is inherently a half-wave rectifier. The second function of the transformer is to raise the voltage level such that the input voltage to the CDVM is sufficiently high to overcome the forward voltage drop of the diodes comprising the CDVM. If the output of the pickup is in the range of ten millivolts, the turns ratio for the transformer is approximately thirty-five to one to assure efficient operation of the CDVM. Finally, the third function of the transformer is to provide a reduction of the effect of the junction capacitance of the diodes in the CDVM. This is desirable to minimize the effect circuit capacitance on resonance in the inductive pickup. The CDVM has an arbitrary number of stages based upon on the output requirements. Since a CDVM has a high output impedance, the output looks like a current-source to its input to the multi-source energy storage interface.

Multi-Source Energy Storage Controller:

The collector device can be extended to includes a plurality of ambient energy collectors and a multi-source ambient energy collector interface. Besides the ambient electromagnetic energy collector, the multi-source ambient energy collector and power supply device may also include an ambient acoustic/vibration energy collector for collecting energy from ambient sound or vibration energy sources, an ambient thermoelectric energy collector for collecting energy from ambient thermal energy sources, and an ambient photovoltaic energy collector for collecting energy from ambient light and/or sunlight.

There are a wide variety of available devices that can be used for collection of several of the commonly available types of ambient energy. These range from photovoltaic materials and collectors that have been under development for many years and are now commercially available for many different applications to very specialized thermoelectric devices utilized to provide power for deep space satellite missions. In addition to light and heat energy collectors, devices that generate electrical signals from acoustic or mechanical vibration are well known.

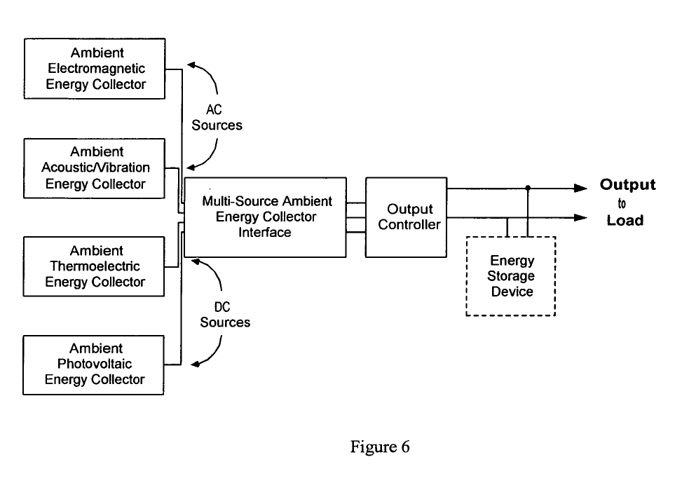

A schematic illustration of a multi-source ambient energy collector is shown in FIG. 6 having a multi-source ambient energy collector interface 60 interfacing with multiple ambient energy collector sources. The interface 60 performs several key functions in allowing collected ambient energy to be usefully employed to power electronic devices. First and most importantly, it must provide a common, low-loss interface to the several different types of ambient energy collectors. This will allow tailoring the ambient energy power supply to the application by harnessing appropriate ambient energy sources to the load. Second, the controller must provide isolation between the various energy collectors to prevent discharge of stored energy during periods in which one collector may not be producing useful output while another is. A third function performed by the controller is to control the supply of energy to the storage device. Since storage can be accomplished either through a passive device like a capacitor or an active electrochemical device like a battery, the controller must be able to accommodate these quite different storage media. By configuring each collector as a current source, all the outputs are summed into the output controller. Each current source is isolated from the others to prevent cross-feeding effects.

Ambient energy transducers can be broadly lumped into two categories: those having AC outputs such as the electromagnetic and acoustic/vibration collectors described above and those have DC outputs like the thermoelectric and photovoltaic collectors. The interface to any AC source will be generally similar to the circuitry connected to the electromagnetic pickup described above, i.e., a transformer and rectifier function. The output of this interface will be designed to approximate an ideal current source.

DC ambient energy transducers generally behave more like ideal voltage sources. A voltage source is not the preferred form for aggregating collected energy since current can only flow from the source when its voltage exceeds the voltage at the load. To maximize the amount of energy collected it is desirable that all output from the ambient energy transducers be supplied to the storage device. To accomplish this, a Norton-equivalent current source can be implemented at the output of each DC interface.

Depending on the application of the ambient power source, the collected energy may be stored in either a capacitor or an electrochemical battery. In a capacitive storage medium, the terminal voltage of the capacitor is equal to the product of the capacitance and stored charge. Thus as more charge (current) is delivered to the storage capacitor, its terminal voltage will continue to rise. For applications in which a fixed or maximum voltage is to be applied to the load, the controller will limit further charge accumulation in the capacitor to that sufficient to maintain the desired terminal voltage. A battery, on the other hand, has a fixed output voltage that is determined by the electrochemical reaction that forms the battery. In this case the controller must monitor the total charge delivered to the battery to maintain the desired terminal voltage under conditions of varying load and output from the ambient energy collectors.

The ambient energy collector and power supply device may be configured as a “smart switch” to act as an encrypted, secured, remotely activated, and tunable mechanism that can be used to trigger power release from the energy storage component for supplying power on demand to the associated energy-using device. It can use the same magnetic coupling of the electromagnetic collector to the magnetic component of the transmitted RF electromagnetic wave to act as a receiver circuit that decodes a “trigger” signal at a selected frequency into a specific voltage level or current pulse that acts as a “wake-up signal” to release energy to the energy-using device. A detection circuit for detecting the trigger signal may be implemented in the output controller or in the multi-source collector interface. The trigger signal may be encoded in the magnetic wave component to generate a voltage level or current pulse sequence that is decrypted by the detection circuit for greater security against detection error or tampering. The use of the magnetic coupling on a small, miniaturized footprint allows the wake-up signal to be detected from RF waves of long wavelengths for transmission to remotely deployed devices that cannot be achieved with conventional electric coupling antenna designs that would require a long antenna length. An encoded “sleep signal” may be transmitted and detected in a similar fashion. This mechanism thus provides a secured triggering method to wake up embedded devices or remote sensor or RFID networks to perform their function, and has a unique capability for preventing tampering for secured operation.

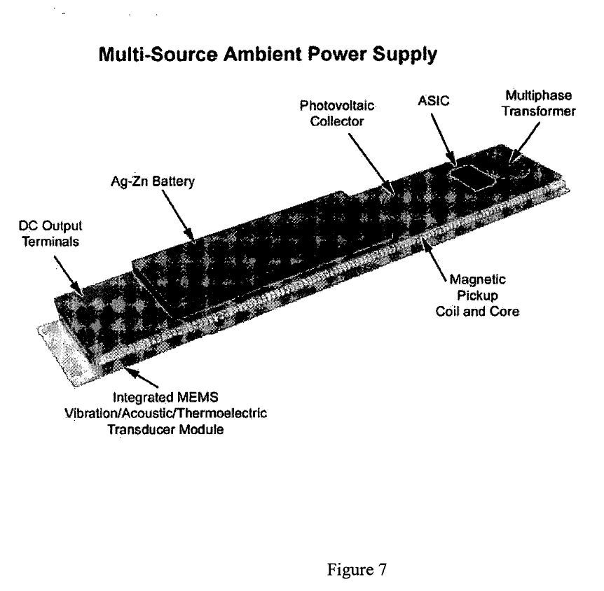

FIG. 7 illustrates a multi-source ambient energy collector and power supply device that may be used as an inexhaustible energy source for sensors, RFID tags, and small electronic devices. It is formed as a small, planar strip that may have physical dimensions of approximately 2.6 inches in length, 0.5 inches in width and approximately 0.125 inch thick. A longer term objective would be to reduce the size of the module to the form factor of a semiconductor chip with the rectification and voltage multiplier components miniaturized to MEMS scale. The lower layer of the strip which would be placed on the ground or supporting surface is formed as an integrated MEMS vibration/acoustic/thermoelectric transducer module. A middle layer is formed as a magnetic pickup coil and core. An upper layer which would face upwardly toward ambient light is formed with a photovoltaic collector, and supports DC output terminals (to which the energy-using device is connected), a high-capacity battery storage such as an Ag—Zn battery, an ASIC chip for the interface module, and a multiphase transformer. With advancements in future battery development, such as new lithium-based battery chemistries with a suitable voltage range for operating the power-using devices, the multi-source ambient energy collector and power supply device can incorporate these low self-discharge, but high energy and power, chemistries for proper drain rate power source applications. The small, low-cost, self-sustaining ambient power supply module could thus extract power from a combination of multiple ambient energy sources, e.g., high and low radio waves, solar and artificial light, thermal gradients, vibrations and acoustic noise. The energy output of multiple ambient energy transducers is integrated with a single, on-module rechargeable battery or other storage device.

The low cost, miniaturized multi-source ambient power supply device is designed to support wireless sensors and RFID tags that are:
Embedded in engines, machinery, pipe lines or other hard-to-access locations.
Remotely deployed over large geographical areas.
Required in miniaturized form factors
Currently powered by batteries that are impractical or too costly to recharge or replace

For defense and security applications, the miniaturized, self-sustaining, power supply may be used for disposable microsensors to support “persistent surveillance” for counter-terrorism efforts in combat zones and urban transit systems; and the continuous monitoring of borders and the perimeters of water supplies, chemical plants and nuclear facilities.

This enabling ambient power technology also has broad application across a broad range of commercial applications and industries. These include: industrial sensors; self-powered actuators for automobiles; battery-less RFID tags; and new home automation, security and fire/smoke detectors systems that never require battery replacement or recharging. As semiconductor advancements continue to reduce the power demand of personal electronic devices, the miniaturized ambient power supply module may also be used to supplement the rechargeable batteries of cell phones, PDAs, and other devices. Future development possibilities also include the design of a microminiaturized, bio-compatible ambient power supply to support the development of enhanced biomedical sensors and non-lethal bio-weapons applications.

It is understood that many modifications and variations may be devised given the above description of the principles of the invention. It is intended that all such modifications and variations be considered as within the spirit and scope of this invention, as defined in the following claims.

1. An ambient energy collector and power supply device comprising:
an ambient electromagnetic energy collector that couples to an ambient electromagnetic field around the device to extract energy from the ambient electromagnetic field, and an associated energy storage device for storing the extracted energy and supplying an energy output therefrom to an energy-using device,
wherein the ambient electromagnetic energy collector has an inductor structure for coupling to a magnetic field component of the ambient electromagnetic field so that it can be substantially reduced in size as compared to an antenna structure for coupling to the electric field component of the ambient electromagnetic field.

2. An ambient energy collector and power supply device according to claim 1, wherein the inductor structure comprises a magnetic core element of high permeability ferromagnetic material that is wrapped in an inductor coil.

3. An ambient energy collector and power supply device according to claim 1, wherein the inductor structure is designed to couple primarily to the magnetic field component of a propagating transverse electromagnetic (TEM) wave.

4. An ambient energy collector and power supply device according to claim 1, wherein the inductor structure provides an induced voltage output from coupling to the magnetic field component of a wide range of frequencies in the ambient electromagnetic field, and said device includes a multi-phase transformer which receives the induced voltage output and is connected to a multi-phase diode voltage multiplier to provide a current source output that is stored in the energy storage device.

5. An ambient energy collector and power supply device according to claim 1, wherein the ferromagnetic material for the magnetic core element is selected from nickel-iron alloys comprising a high percentage of nickel, smaller percentage of iron, and very small percentage of an added element such as silicon, molybdenum, or copper.

6. An ambient energy collector and power supply device according to claim 1, further comprising another ambient energy collector selected from the group consisting of: an ambient acoustic/vibration energy collector; an ambient thermoelectric energy collector; and an ambient photovoltaic energy collector.

7. A method for collecting ambient energy and supplying power to a low-power energy-using device deployed or embedded remotely in a field application comprising:
coupling an ambient electromagnetic energy collector to a magnetic field component of an ambient electromagnetic field in order to extract energy from the ambient electromagnetic field, and storing the extracted energy in an associated energy storage device, so that power can be supplied therefrom to the low-power energy-using device.

8. A method for collecting ambient energy and supplying power according to claim 7, wherein the ambient electromagnetic energy collector has an inductor structure comprising a magnetic core element of high permeability ferromagnetic material that is wrapped in an inductor coil.

9. A method for collecting ambient energy and supplying power according to claim 7, which is used to supply power to an energy-using device selected from the group consisting of: embedded devices; wireless sensors; RFID tags; disposable microsensors for “persistent surveillance”; continuous monitoring devices distributed over large areas; industrial sensors; self-powered actuators for automobiles; home automation, security and fire/smoke detectors systems; biomedical sensors; and bio-weapons sensors.

10. A method for collecting ambient energy and supplying power according to claim 7, further combining the ambient electromagnetic energy collector with another ambient energy collector selected from the group consisting of: an ambient acoustic and/or vibration energy collector; an ambient thermoelectric energy collector; and an ambient photovoltaic energy collector.

11. A multi-source ambient energy collector and power supply device for supplying power to a low-power energy-using device deployed or embedded remotely in a field application comprising:
a plurality of types of ambient energy collectors each for extracting energy from a different source of ambient energy available in the field around the device; and
a multi-source ambient energy collector interface which is coupled to the different outputs of the plurality of types of ambient energy collectors and converts the outputs into a common electrical form for storage in an associated electrical energy storage device.

12. A multi-source ambient energy collector and power supply device according to claim 11, wherein the multi-source ambient energy collector interface controls the supply of energy converted from the outputs of the plurality of types of ambient energy collectors to the electrical energy storage device by adapting the converted electrical output in correspondence to operating requirements of the electrical energy storage device.

13. A multi-source ambient energy collector and power supply device according to claim 11, wherein the electrical energy storage device is a type selected from the group consisting of: a passive electrical energy storage device like a capacitor; and an active electrochemical energy storage device like a battery.

14. A multi-source ambient energy collector and power supply device according to claim 11, wherein the plurality of types of ambient energy collectors includes types selected from the group consisting of: ambient energy collectors having AC outputs; and ambient energy collectors having DC outputs.

15. A multi-source ambient energy collector and power supply device according to claim 11, wherein the plurality of types of ambient energy collectors includes types selected from the group consisting of: electromagnetic energy collectors; acoustic/vibration energy collectors; thermoelectric energy collectors; and photovoltaic energy collectors.

16. A multi-source ambient energy collector and power supply device according to claim 11, wherein the plurality of types of ambient energy collectors includes at least an ambient electromagnetic energy collector having an inductor structure for coupling to a magnetic field component of an ambient electromagnetic field so that the device can be substantially reduced in size as compared to an antenna structure for coupling to the electric field component of the ambient electromagnetic field.

17. A multi-source ambient energy collector and power supply device according to claim 16, wherein the ambient energy collector interface includes a detector circuit for detecting a trigger signal encoded in an electromagnetic wave transmitted to the device which is decoded using the inductor structure of the ambient electromagnetic energy collector for coupling to an encoded magnetic field component of the transmitted wave.

18. An ambient electromagnetic energy collector that couples to an ambient electromagnetic field around the device to extract energy from the ambient electromagnetic field, having an inductor structure for coupling to a magnetic field component of the ambient electromagnetic field so that the collector can be substantially reduced in size as compared to an antenna structure for coupling to the electric field component of the ambient electromagnetic field.

19. An ambient electromagnetic energy collector according to claim 18, wherein the inductor structure comprises a magnetic core element of high permeability ferromagnetic material that is wrapped in an inductor coil.

20. An ambient electromagnetic energy collector according to claim 18, wherein the inductor structure provides an induced voltage output from coupling to the magnetic field component of a wide range of frequencies in the ambient electromagnetic field, and said device includes a multi-phase transformer which receives the induced voltage output and is connected to a multi-phase diode voltage multiplier to provide a current source output.

21. An ambient electromagnetic energy collector according to claim 18, wherein the ferromagnetic material for the magnetic core element is selected from nickel-iron alloys comprising a high percentage of nickel, smaller percentage of iron, and very small percentage of an added element such as silicon, molybdenum, or copper.

22. An ambient electromagnetic energy collector according to claim 18, further including a detector circuit for detecting a trigger signal encoded in an electromagnetic wave transmitted to the device which is decoded using the inductor structure of the ambient electromagnetic energy collector for coupling to an encoded magnetic field component of the transmitted wave.
